(19) United States
(12) Patent Application Publication
(10) Pub. No.: US 2021/0341802 A1
(43) Pub. Date: Nov. 4, 2021

(54) PIXEL ELECTRODE OF DISPLAY PANEL, DISPLAY PANEL AND DISPLAY DEVICE

(71) Applicants: HKC CORPORATION LIMITED, Shenzhen (CN); CHONGQING HKC OPTOELECTRONICS TECHNOLOGY CO., LTD., Chongqing (CN)

(72) Inventor: Shishuai HUANG, Chongqing (CN)

(21) Appl. No.: 16/340,690

(22) PCT Filed: Nov. 19, 2018
(86) PCT No.: PCT/CN2018/116138

§ 371 Date: Apr. 10, 2019

(30) Foreign Application Priority Data
Oct. 30, 2018 (CN) 201811275217.8

(51) Int. Cl. G02F 1/1343

(52) U.S. Cl. CPC G02F 1/134309; G02F 1/13775

(57) ABSTRACT

The present application discloses a pixel electrode of a display panel, the display panel and a display device. Branches are away from a first trunk or a second trunk, and an end portion, which forms a storage capacitor together with a common electrode line, of each branch is an outer end portion; and there is a gap between at least two adjacent outer end portions.

The present application claims priority to the Chinese Patent Application No. CN201811275217.8, filed with National Intellectual Property Administration, PRC on Oct. 30, 2018, and entitled “PIXEL ELECTRODE OF DISPLAY PANEL, DISPLAY PANEL AND DISPLAY DEVICE”, which is incorporated herein by reference in its entirety.

### TECHNICAL FIELD

The present application relates to the technical field of display, and in particular, to a pixel electrode of a display panel, the display panel and a display device.

### BACKGROUND

The statements herein merely provide background information related to the present application and do not necessarily constitute the prior art.

With the development and advancement of technology, flat panel displays have become mainstream display products due to their thin bodies, power saving and low radiation, etc., and have been widely used. The flat panel displays include a thin film transistor-liquid crystal display (TFT-LCD), an organic light-emitting diode (OLED) display, and the like. The thin film transistor-liquid crystal display controls a rotation direction of liquid crystal molecules to refract light of a backlight module to produce a picture, and has many advantages such as thin body, power saving, and no radiation. The organic light-emitting diode display is made of organic light-emitting diodes, and has many advantages such as self-illumination, short response time, high definition and contrast, flexible display and large-area full-color display.

A pretilt angle is formed in the process of production of a display panel using a polymer stabilized vertical alignment (PSVA) technology; that is, a pretilt angle is formed by UV curing under the driving of a voltage. During the UV curing process, the voltage of a common electrode line is constantly changing, and the display panel is prone to dark lines.

### SUMMARY

The present application provides a pixel electrode of a display panel, a display panel and a display device, where the display panel and the display device are less prone to dark lines.

To achieve the above objective, the present application provides a pixel electrode of a display panel, where the display panel includes a first substrate, and the first substrate includes a pixel electrode and common electrode lines;

the pixel electrode includes:

a first trunk;

a second trunk intersecting with the first trunk; and

a plurality of branches connected with the first trunk or the second trunk;

the branches are away from the first trunk or the second trunk, and an end portion, which forms a storage capacitor together with the common electrode line, of each branch is an outer end portion; and there is a gap between at least two adjacent outer end portions.

Optionally, the common electrode lines are disposed corresponding to two edge sides of the pixel electrode; and

corresponding to the two edge sides, there is a gap between the outer end portions of at least two adjacent branches of each edge side.

The first main trunk is disposed horizontally and located at a middle portion of the pixel structure, and the second trunk is disposed vertically and located at a middle portion of the pixel structure; and two side edges parallel to the first trunk are edge sides. Areas of the two edge sides are more easily subjected to dark lines.

Optionally, corresponding to the two edge sides, there is a gap between the outer end portions of two adjacent branches.

Optionally, the common electrode lines are disposed corresponding to at least one edge side of the pixel electrode;

the pixel electrode also includes fence trunks, and the fence trunks connect the outer end portions of all or some of the branches;

the edge sides are disposed corresponding to the common electrodes lines; there is a gap between the outer end portions of each of the branches in intermediate areas of the edge sides, and each outer end portion of a first end area and a second end area of the edge side are respectively integrally connected through the fence trunks.

An area of each edge side close to the first trunk is the intermediate area, and the range of the intermediate area can be adjusted according to the actual situation; correspondingly, the number of the set gaps between the outer end portions of the branches can be adjusted according to the actual situation; an area at the upper end of the edge side is the first end area, and an area at the lower end of the edge side is the second end area.

The fence trunks of the first end areas can be integrally connected through the fence trunks at the upper side of the pixel electrode; and the fence trunks of the second end areas can be integrally connected through the fence trunks at the lower side of the pixel electrode.

Optionally, the common electrode lines are disposed corresponding to two edge sides of the pixel electrode.

Optionally, the first trunk is horizontally disposed at a middle portion of the pixel electrode, and the second trunk is vertically disposed at a middle portion of the pixel electrode;

the common electrode lines are disposed corresponding to two edge sides of the pixel electrode; and

an end portion of the first trunk corresponding to the common electrode lines is hollowed out.

Optionally, the gaps between the outer end portions of each of the branches are equal.

Optionally, a structure of a fence trunk between the outer end portions of some of the branches is reserved, i.e., two or more adjacent outer end portions are connected with each other.

Another objective of the present application is to provide a display panel including the pixel electrode as described above.

Another objective of the present application is to provide a display device including the display panel as described above.

The inventors have found by study that in the pixel structure formed by integrally connecting the outer end portions of the branches through the fence trunks, the fence trunks on at least one side have an overlapping area with the common electrode lines; when the display panel using a PSVA technology forms a pretilt angle by UV curing, liquid crystal at an area of the edge side is affected by voltages of the fence trunks, the branches and the common electrode lines, while the voltage of the common electrode lines needs to be gradually increased and change during LV curing, so that changes of the voltage of the common electrode lines also affect the voltages of the fence trunks and the branches, resulting in an unstable electric field of the area of the edge side. The liquid crystal deflection in the area of the edge side is also disordered, which is prone to dark lines. Although the occurrence of the dark lines can be reduced by keeping the voltage of each common electrode line constant during the UV curing process, such an arrangement results in that the voltage of the common electrode line cannot be adjusted and changed, thereby limiting the degree of freedom of manufacture procedures.

In this solution, there is a gap between at least two outer end portions corresponding to the common electrode lines; the fence trunk at the corresponding common electrode line is removed or partially removed while an overlapping area between the outer end portion of the branch and the common electrode line is reserved to form a storage capacitor, so that the outer end portions are not integrally connected, and there is no fence trunk causing the outer end portions to be integrally connected as a whole; the liquid crystal at the area of the edge side is mainly affected by voltages of the branches and the common electrode lines, and the liquid crystal deflection at the area of the edge side is less likely to be disordered, so that the occurrence of dark lines is reduced. At the same time, according to the effect of an edge electric field, after the outer end portions have a gap, the electric field of the outer end portions becomes stronger, and is stronger than the electric field of the common electrode line to the outer end portion, so that the liquid crystal deflection of the area of the edge side corresponding to the common electrode line is mainly affected by an electric field of the branches, and the influence of the electric field, and the influence of the change of the voltage of the common electrode line on the liquid crystal deflection is also relatively reduced; therefore, the disorder does not occur easily, the occurrence of dark lines is reduced, and the limitation to the degree of freedom of manufacture procedures is small.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts.

In the accompanying drawings:

FIG. 1 is a schematic structural view of an undisclosed pixel electrode;

FIG. 2 is an enlarged view of a portion A in FIG. 1;

FIG. 3 is a schematic structural view of a pixel electrode according to an embodiment of the present application;

FIG. 4 is a schematic structural view of a pixel electrode according to an embodiment of the present application;

FIG. 5 is a schematic structural view of another pixel electrode according to an embodiment of the present application; and

FIG. 6 is a schematic view of a display device according to an embodiment of the present application.

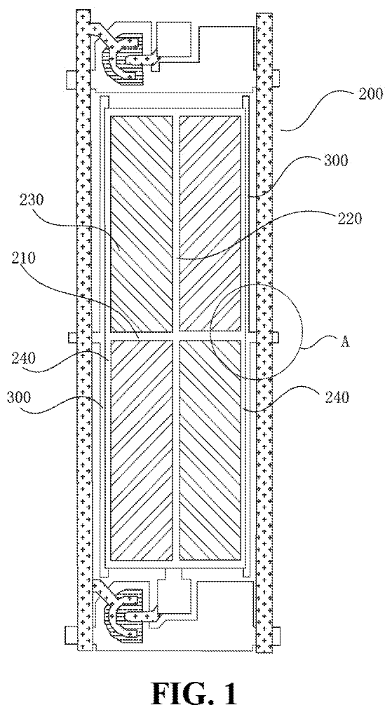

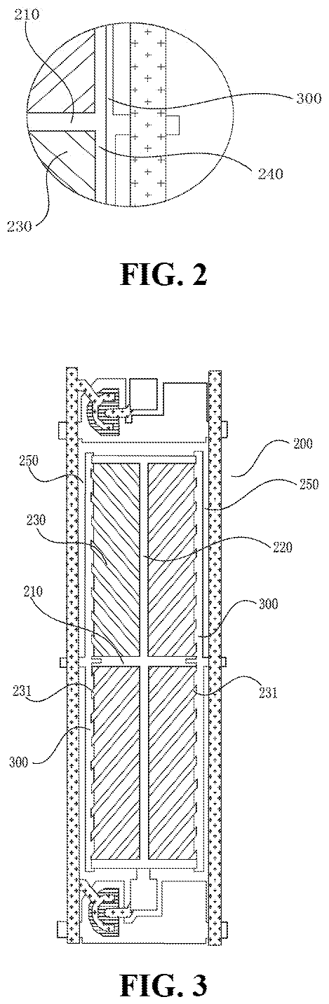

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms “first”, “second” are merely for a descriptive purpose, and cannot to be understood to indicate or imply relative importance, or implicitly indicate the number of the indicated technical features. Hence, the features defined by “first” and “second” can explicitly or implicitly include one or more features. In the description of the present application, “a plurality of” means two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or electrically connected; or directly connected or indirectly connected through an intermediate medium, or in an internal communication between two elements. The specific meanings about the foregoing terms in the present application may be understood by those skilled in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “comprise” and/or “include” used herein specify the presence of the stated features, integers, steps, operations, elements and/or components, but do not preclude the presence or addition of one or more other features, integers, steps, operations, elements, components and/or combinations thereof.

The present application will be optionally described below with reference to the accompanying drawings and embodiments.

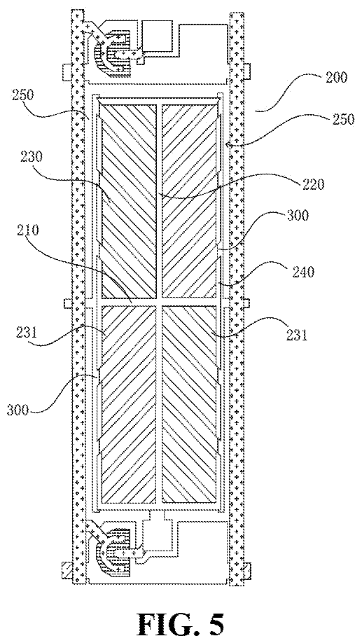

As shown in FIG. 3 to FIG. 5, an embodiment of the present application discloses a pixel electrode 200 of a display panel, where the display panel 10 includes a first substrate 100, and the first substrate 100 includes the pixel electrode 200 and common electrode lines 300;

the pixel electrode 200 includes:

a first trunk 210;

a second trunk 220 intersecting with the first trunk 210; and

a plurality of branches 230 connected with the first trunk 210 or the second trunk 220;

the branches 230 are away from the first trunk 210 or the second trunk 220, and an end portion, which forms a storage capacitor together with the common electrode line 300, of each branch is an outer end portion 231; and there is a gap between at least two adjacent outer end portions 231.

The inventors have found by study that in the pixel structure formed by integrally connecting the outer end portions 231 of the branches 230 through the fence trunks 240, the fence trunks 240 on at least one side have an overlapping area with the common electrode lines 300; when the display panel 10 using a PSVA technology forms a pretilt angle by UV curing, liquid crystal at an area of the edge side 250 is affected by voltages of the fence trunks 240, the branches 230 and the common electrode lines 300, while the voltage of the common electrode lines 300 needs to be gradually increased and change during UV curing, so that changes of the voltage of the common electrode lines 300 also affects the voltages of the fence trunks 240 and the branches 230, resulting in an unstable electric field of the area of the edge side 250. The liquid crystal deflection in the area of the edge side 250 is also disordered, which is prone to dark lines. Although the occurrence of the dark lines can be reduced by keeping the voltage of each common electrode line 300 constant during the LV curing process, such an arrangement results in that the voltage of the common electrode line 300 cannot be adjusted and changed, thereby limiting the degree of freedom of manufacture procedures.

In this solution, there is a gap between at least two outer end portions 231 corresponding to the common electrode lines 300; the fence trunk 240 at the corresponding common electrode line 300 is removed or partially removed while an overlapping area between the outer end portion of the branch 230 and the common electrode line is reserved to form a storage capacitor, so that the outer end portions 231 are not integrally connected, and there is no fence trunk 240 causing the outer end portions 231 to be integrally connected as a whole; the liquid crystal at the area of the edge side 250 is mainly affected by voltages of the branches 230 and the common electrode lines 300, and the liquid crystal deflection at the area of the edge side 250 is less likely to be disordered, so that the occurrence of dark lines is reduced. At the same time, according to the effect of an edge electric field, after the outer end portions 231 have a gap, the electric field of the outer end portions 231 becomes stronger, and is stronger than the electric field of the common electrode line 300 to the outer end portion 231, so that the liquid crystal deflection of the area of the edge side 250 corresponding to the common electrode line 300 is mainly affected by an electric field of the branches 230, and the influence of the electric field, and the influence of the change of the voltage of the common electrode line 300 on the liquid crystal deflection is also relatively reduced; therefore, the disorder does not occur easily, the occurrence of dark lines is reduced, and the limitation to the degree of freedom of manufacture procedures is small.

In an embodiment, as shown in FIG. 3, the common electrode lines 300 are disposed corresponding to two edge sides 250 of the pixel electrode 200:

corresponding to the two edge sides 250, there is a gap between the outer end portions 231 of at least two adjacent branches 230 of each edge side 250.

The first main trunk 210 is disposed horizontally and located at a middle portion of the pixel structure, and the second trunk 220 is disposed vertically and located at a middle portion of the pixel structure; and two side edges parallel to the first trunk 210 are edge sides 250. Areas of the two edge sides 250 are more easily subjected to dark lines. In this solution, there is a gap between the outer end portions at the two edge sides 250, which can reduce dark lines of the two edge sides 250.

In an embodiment, as shown in FIG. 3, there is a gap between the outer end portions 231 of every two adjacent branches 230.

In this solution, there is a gap between the outer end portions 231, so that the outer end portions are not integrally connected, and there is no fence trunk 240 that implements integral connection; the liquid crystal at the area of the edge side 250 is affected by voltages of the branches 230 and the common electrode lines 300, and the liquid crystal deflection at the area of the edge side 250 is less likely to be disordered, so that the occurrence of dark lines is reduced. At the same time, according to the effect of an edge electric field, after a gap is set between the outer end portions 231, the electric field is strengthened, and is stronger than the electric field of the common electrode line 300 to the outer end portion 231, so that the liquid crystal deflection of the area of the edge side 250 corresponding to the common electrode line 300 is mainly affected by an electric field of the branches 230, and the influence of the electric field, and the influence of the change of the voltage of the common electrode line 300 on the liquid crystal deflection is also relatively reduced; therefore, the disorder does not occur easily, the occurrence of dark lines is reduced, and the limitation to the degree of freedom of manufacture procedures is small.

In an embodiment, as shown in FIG. 3, the first trunk 210 is horizontally disposed at a middle portion of the pixel electrode 200, and the second trunk 220 is vertically disposed at a middle portion of the pixel electrode 200;

the common electrode lines 300 are disposed corresponding to two edge sides 250 of the pixel electrode 200; and

an end portion of the first trunk 210 corresponding to the common electrode lines 300 is hollowed out.

A width of the first trunk 210 is larger than that of each branch 230. An end area of the first trunk 210 is subjected to a greater influence of the voltage of the common electrode lines 300, and is more prone to dark lines. In this solution, the end portion of the first trunk 210 is hollowed out, and the structure of the end portion of the first trunk 210 is more similar to that of each branch 230, which can reduce dark lines of this area. The common electrode lines 300 may be disposed only on the two edge sides 250, or may be overlapped on the first trunk 210 on this basis, and disposed below the first trunk 210, which increases storage capacitance compared with such an arrangement that the common electrode lines 300 are disposed only on the two edge sides 250.

In an embodiment, as shown in FIG. 3, gaps between the outer end portions 231 of each branch 230 are equal.

In this solution, the gaps between the outer end portions 231 of each branch 230 are equal, so that the electric field distribution of the edge sides 250 is more uniform, the liquid crystal deflection is more uniform, and the edge side 250 is less prone to dark lines.

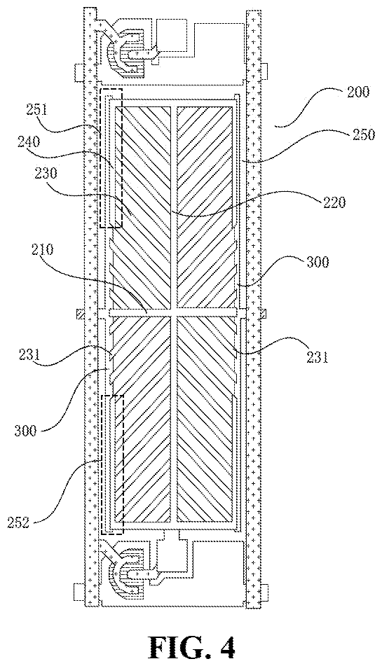

In an embodiment, the difference from the aforementioned embodiment is, referring to FIG. 4, that the common electrode lines 300 are disposed corresponding to at least one edge side 250 of the pixel electrode 200;

the pixel electrode 200 also includes fence trunks 240, and the fence trunks 240 connect the outer end portions 231 of all or some of the branches;

the edge sides 250 are disposed corresponding to the common electrode lines 300, and there is a gap between the outer edge portions 231 of each branch 230 of an intermediate area of the edge side 250, and the outer end portions 231 of a first end area 251 and a second end area 252 of the edge side 250 are integrally connected respectively through the fence trunks 240.

An area of each edge side 250 close to the first trunk 210 is the intermediate area, and the range of the intermediate area can be adjusted according to the actual situation; correspondingly, the number of the set gaps between the outer end portions 231 of the branches 230 can be adjusted according to the actual situation; an area at the upper end of the edge side 250 is the first end area 251, and an area at the lower end of the edge side 250 is the second end area 252.

The fence trunks 240 of the first end areas 251 can be integrally connected through the fence trunks 240 at the upper side of the pixel electrode 200; and the fence trunks 240 of the second end areas 252 can be integrally connected through the fence trunks 240 at the lower side of the pixel electrode 200.

Dark lines of the intermediate area of the edge side 250 are more severe. In this solution, gaps are set between the outer end portions 231 of the intermediate area of the edge side 250, which can reduce the occurrence of dark lines in a large extent, at the same time, the outer end portions 231 of areas at the two ends of the edge side 250 are integrally connected, and the pixel electrode 200 and the common electrode line 300 have a larger overlapping area; storage capacitance formed between the common electrode line 300 and the pixel electrode 200 is larger, and the display of the display panel 10 is more stable.

In an embodiment, referring to FIG. 4, the common electrode lines 300 are disposed corresponding to two edge sides 250 of the pixel electrode 200.

In this solution, an overlapping area of the pixel electrode 200 and the common electrode line 300 becomes large; storage capacitance formed between the common electrode line 300 and the pixel electrode 200 is larger, and the display of the display panel 10 is more stable.

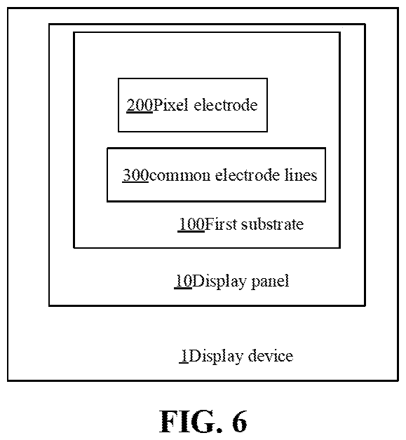

In an embodiment, the difference from the aforementioned embodiment is, referring to FIG. 6, that a structure of a fence trunk 240 between the outer end portions 231 of some of the branches 230 is reserved, i.e., two or more adjacent outer end portions 231 are connected with each other.

There is an overlapping area between the common electrode line 300 and the pixel electrode 200, so that a storage capacitor can be formed. In this solution, two or more adjacent outer end portions 231 are connected with each other; storage capacitance formed between the common electrode line 300 and the pixel electrode 200 is larger, and the display of the display panel 10 is more stable.

Another objective of the present application is to provide a display panel. Referring to FIG. 6, the display panel includes a first substrate 100;

the first substrate 100 includes the aforementioned pixel electrode 200 and the common electrode lines 300 described above. The common electrode lines 300 are disposed on the first substrate 100, and disposed corresponding to both edge sides 250 of the pixel electrode 200.

In an embodiment, the display panel 10 includes the pixel electrode 200 described above; dark lines are less likely to occur, and the limitation to the degree of freedom of manufacture procedures of the display panel 10 is small.

Another objective of the present application is to provide a display device. Referring to FIG. 6, the display device includes the display panel 10 as described above.

The display device 1 includes the aforementioned panel; dark lines are less likely to occur, and the limitation to the degree of freedom of manufacture procedures of the display device 1 is small.

The technical solution of the present application can be widely applied to a twisted nematic (TN) panel, an in-plane switching (IPS) panel,

or a multi-domain vertical alignment (MVA) panel, and of course, the panel may also be other types of panels, as long as the panels are suitable.

The above are detailed descriptions of the present application in conjunction with the specific optional embodiments, but the specific implementation of the present application cannot be determined as being limited to these descriptions. For a person of ordinary skill in the art to which the present application pertains, a number of simple deductions or substitutions may also be made without departing from the concept of the present application. All these should be considered as falling within the scope of protection of the present application.

What is claimed as:

1. A pixel electrode of a display panel, wherein the display panel comprises a first substrate, and the first substrate comprises a pixel electrode and common electrode lines:
the pixel electrode comprises:
a first trunk;
a second trunk intersecting with the first trunk; and
a plurality of branches connected with the first trunk or the second trunk;
the branches are away from the first trunk or the second trunk, and an end portion, which forms a storage capacitor together with the common electrode line, of each branch is an outer end portion; and there is a gap between at least two adjacent outer end portions.

2. The pixel electrode of a display panel according to claim 1, wherein the common electrode lines are disposed corresponding to two edge sides of the pixel electrode; and
corresponding to the two edge sides, there is a gap between the outer end portions of at least two adjacent branches of each edge side.

3. The pixel electrode of a display panel according to claim 2, wherein corresponding to the two edge sides, there is a gap between the outer end portions of two adjacent branches.

4. The pixel electrode of a display panel according to claim 1, wherein the common electrode lines are disposed corresponding to at least one edge side of the pixel electrode;
the pixel electrode also comprises fence trunks, and the fence trunks connect all or some of the outer end portions;
the edge sides are disposed corresponding to the common electrodes lines; there is a gap between the outer end portions of each of the branches in intermediate areas of the edge sides, and each outer end portion of a first end area and a second end area of the edge side are respectively integrally connected through the fence trunks.

5. The pixel electrode of a display panel according to claim 4, wherein the common electrode lines are disposed corresponding to two edge sides of the pixel electrode.

6. The pixel electrode of a display panel according to claim 1, wherein the first trunk is horizontally disposed at a middle portion of the pixel electrode, and the second trunk is vertically disposed at a middle portion of the pixel electrode;
the common electrode lines are disposed corresponding to two edge sides of the pixel electrode; and
an end portion of the first trunk corresponding to the common electrode lines is hollowed out.

7. The pixel electrode of a display panel according to claim 3, wherein gaps between the outer end portions of each of the branches are equal.

8. The pixel electrode of a display panel according to claim 1, wherein a structure of a fence trunk between the outer end portions of some of the branches is reserved, i.e., two or more adjacent outer end portions are connected with each other.

9. A display panel, comprising a first substrate, wherein the first substrate comprises a pixel electrode and common electrode lines;
the pixel electrode comprises:
a first trunk;
a second trunk intersecting with the first trunk; and
a plurality of branches connected with the first trunk or the second trunk;
the branches are away from the first trunk or the second trunk, and an end portion, which forms a storage capacitor together with the common electrode line, of each branch is an outer end portion; and there is a gap between at least two adjacent outer end portions.

10. The pixel electrode of a display panel according to claim 9, wherein the common electrode lines are disposed corresponding to two edge sides of the pixel electrode;
corresponding to the two edge sides, there is a gap between the outer end portions of at least two adjacent branches of each edge side.

11. The pixel electrode of a display panel according to claim 10, wherein corresponding to the two edge sides, there is a gap between the outer end portions of two adjacent branches.

12. The pixel electrode of a display panel according to claim 9, wherein the common electrode lines are disposed corresponding to at least one edge side of the pixel electrode;
the pixel electrode also comprises fence trunks, and the fence trunks connect all or some of the outer end portions;
the edge sides are disposed corresponding to the common electrodes lines; there is a gap between the outer end portions of each of the branches in intermediate areas of the edge sides, and each outer end portion of a first end area and a second end area of the edge side are respectively integrally connected through the fence trunks.

13. The pixel electrode of a display panel according to claim 12, wherein the common electrode lines are disposed corresponding to two edge sides of the pixel electrode.

14. The pixel electrode of a display panel according to claim 9, wherein the first trunk is horizontally disposed at a middle portion of the pixel electrode, and the second trunk is vertically disposed at a middle portion of the pixel electrode;
the common electrode lines are disposed corresponding to two edge sides of the pixel electrode; and
an end portion of the first trunk corresponding to the common electrode lines is hollowed out.

15. The pixel electrode of a display panel according to claim 11, wherein gaps between the outer end portions of each of the branches are equal.

16. The pixel electrode of a display panel according to claim 9, wherein a structure of a fence trunk between the outer end portions of some of the branches is reserved, i.e., two or more adjacent outer end portions are connected with each other.

17. A display device, comprising a display panel, wherein the display panel comprises a first substrate, and the first substrate comprises a pixel electrode and common electrode lines;
the pixel electrode comprises:
a first trunk;
a second trunk intersecting with the first trunk; and
a plurality of branches connected with the first trunk or the second trunk;
the branches are away from the first trunk or the second trunk, and an end portion, which forms a storage capacitor together with the common electrode line, of each branch is an outer end portion; and there is a gap between at least two adjacent outer end portions.
